(19) United States
(12) Patent Application Publication
(10) Pub. No.: US 2009/0283730 A1
(43) Pub. Date: Nov. 19, 2009

(54) GIRTH STRAP TIGHTENER FOR A SADDLE

(76) Inventors: Jeffrey C. Rice, Celina, OH (US); Daniel J. Kissing, Cincinnati, OH (US); Samuel L. Belcher, Moscow, OH (US); Paul E. Whitehead, Mount Orab, OH (US)

Correspondence Address: WOOD, HERRON & EVANS, LLP, 2700 CAREW TOWER, 441 VINE STREET, CINCINNATI, OH, 45202, US

(21) Appl. No.: 12/121,829

(22) Filed: May 16, 2008

(51) Int. Cl. B68B 1/00; B25B 25/00

(52) U.S. Cl. 254/243; 54/1

(57) ABSTRACT

A hand-held lightweight tightener for tightening the girth strap of a saddle has a handle for leverage, a broad curved cam surface to act as a fulcrum, and a prong to fit in a belt hole on the girth strap. This tightening device can be used to engage and pull at an easily accessible belt hole so that more of the billet strap can be brought through the buckle on the girth strap. Once more billet strap is brought through the buckle, the strap can be buckled through one of the holes of the billet strap, and the tightener removed. The tightener is suitable for hanging on a saddle while riding. The tightener may be used for belt systems other than on a saddle. Optionally, the device has a hoof pick and a compass.

### FIELD OF THE INVENTION

The present invention relates to a device for tightening belts, specifically the girth strap of a saddle.

### BACKGROUND OF THE INVENTION

A saddle is fastened by a girth strap. Girth straps start on one side of the saddle, pass underneath the horse's belly, and fasten to a billet strap on the other side of the saddle. Frequently a horse, sensing that a saddle will be fastened, inflates his girth. A person may not have sufficient strength to properly tighten the girth strap, especially on a horse with an inflated girth. Therefore, it would be useful to have a device that a person could use to apply leverage to the girth strap to help them tighten it around the horse.

A girth strap is similar to a belt. Belts, buckles, and saddles with girth straps, have been used for a long time. As used here, a belt may be one continuous piece, or it may be two separate pieces. A typical belt has an end with several holes, and a buckle with a prong that will pass through a hole selected from several.

In the past, belts were used in many ways that are no longer common. Devices that we think of today as made of metal were formerly made of leather and canvas, and were secured by belts. Therefore, there are many U.S. patents directed to stretching and securing belts. Some of these are specifically for saddles but the majority are not.

An example of a tool for tightening belts or girths is in U.S. Pat. No. 427,304 to Eagan. Like many devices of the time, it is made of several metallic moving parts, and is therefore heavy and complicated to manufacture. Also, as in many devices of the time, there is a prong that sticks through a belt hole and a hook that grabs the belt buckle. A problem in using this device to tighten a girth is that the prong would drag along the skin of the horse or the surface of the saddle. The belt tightener in U.S. Pat. No. 491,728 to Miller would likewise have the same problem.

A belt stretcher of U.S. Pat. No. 267,512 issued to Frost is a similar device to the one just described. Its curved ends would have less impact on a horse and saddle than the previously mentioned devices, but it too has multiple metal parts that move in relation to each other, making it expensive and heavy. This patent was not directed towards securing a girth strap.

A common characteristic of the before mentioned patents is they are used before the loose end (having the holes) of the belt reaches and enters the fixed end, having the buckle. To the contrary, U.S. Pat. No. 786,651 issued to Lanning describes a belt-tightener for use after the loose end of the belt has passed through the buckle. This device has a long shank and a long rod that acts as a fulcrum. This device does not have a long range of motion as is found in the current invention.

A device structurally similar to the current invention is in U.S. Pat. No. 599,142 issued to Ellis. It is structurally similar in that its handle B and its prong E are both extended in the same direction from the fulcrum C. It also does not have parts that move relative to one another. However, to use the Ellis device, a specialized and unusual belt must be present. The belt must have not only holes in its loose or tongue-end, but also in its buckle end. That is because the prong identified as C in the patent has to have a hole F in which to fit.

More recently, U.S. Pat. No. 5,226,282 to Meyers specifically addresses tightening the girth strap on a saddle. This device has a flexible strap with a hook at one end. The device is used by placing the hook in a hole on the billet strap, passing the flexible strap through the buckle on the girth strap, and then grabbing the flexible strap. Pulling upwards on the flexible strap brings the two belt ends into an interlocking relationship. However, this device does not make use of a lever to multiply the strength of the person. Use of this device would also be uncomfortable in the hand.

Because of at least the aforementioned shortcomings of using the prior devices to tighten the girth strap of a saddle, there exists a need for a simple device, which is inexpensive to make, safe to use around horses, and easy to maintain.

### SUMMARY OF THE INVENTION

To achieve the foregoing objects, and in accordance with the purposes of the invention as embodied and broadly described, one embodiment of a device for tightening a belt, for example a girth strap, around an object, for example, a horse, comprises a cam with an arcuate surface that rotates over a holed-end of the belt. A handle emanates from the cam at a first end of the arcuate surface. At the opposite end of the arcuate surface there is a prong. The prong is sized to fit in a belt hole. The prong is approximately parallel to the longitudinal axis of the handle. The device has a range of motion from a starting position whereat the prong lies between the handle and the object when the belt is loose, to an ending position whereat the handle lies between the prong and the object when the belt is tight.

### BRIEF DESCRIPTION OF THE DRAWINGS

These and other features, aspects, and advantages of the present invention will become better understood with regard to the following description, appended claims and accompanying drawings wherein:

FIG. 1 illustrates an embodiment of the current invention.

FIG. 2 illustrates the embodiment of FIG. 1 being used, in a first, position.

FIG. 3 illustrates the embodiment of FIG. 1 being used, in a second position.

FIG. 4 illustrates features for another embodiment of the current invention.

FIG. 5 illustrates features for another embodiment of the current invention.

### DETAILED DESCRIPTION

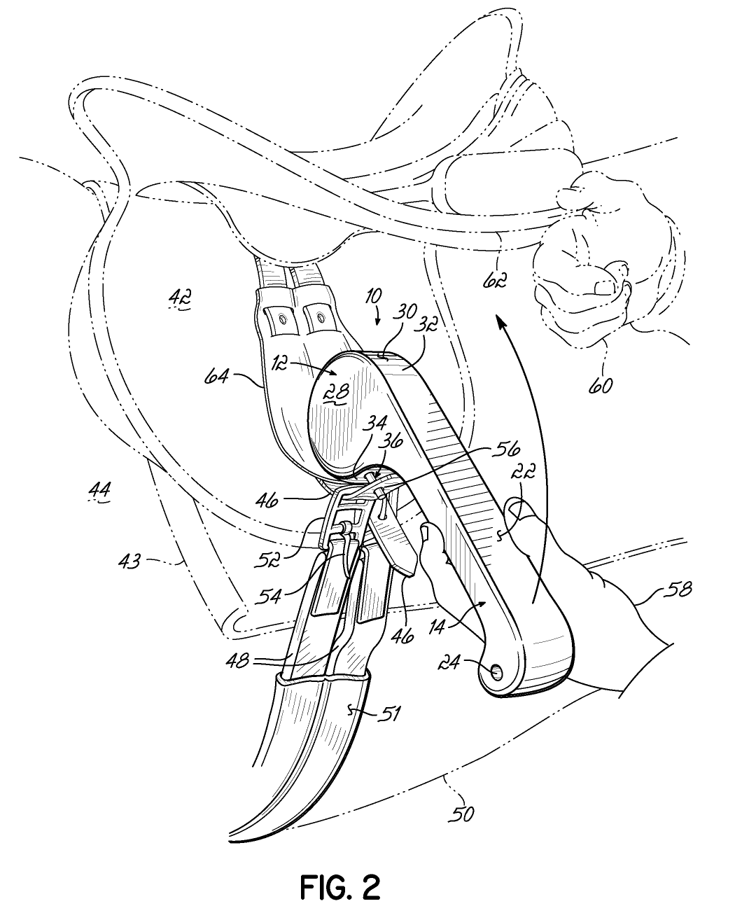

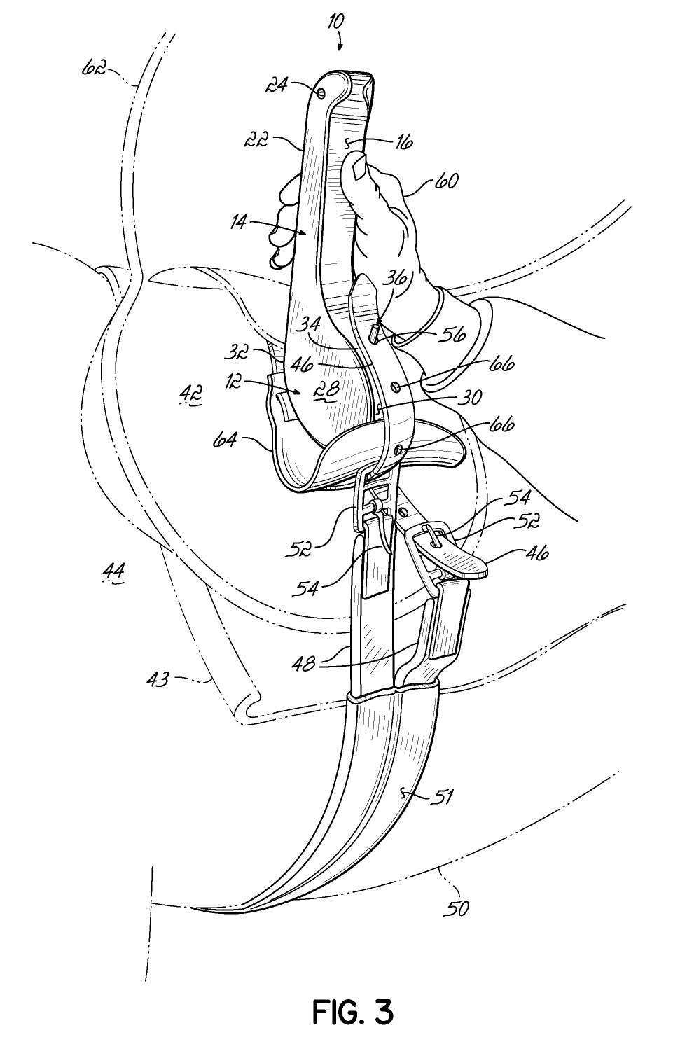

The term “aft” and “front” or “forward” have been used in a manner that is consistent with the front and back of a horse, seen in FIGS. 2 and 3.

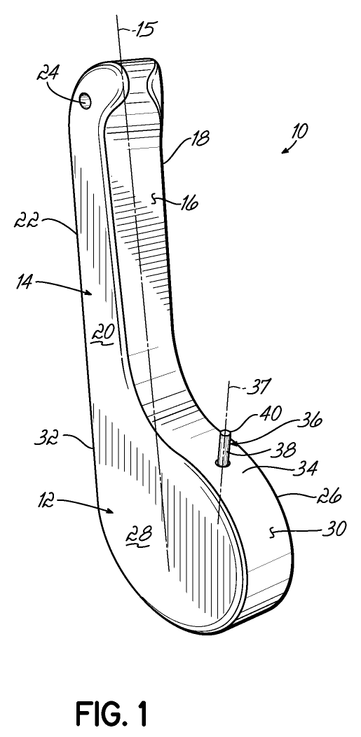

Referring now to the drawings, FIG. 1 illustrates an embodiment of the current invention. A saddlery device 10 has a cam portion 12 and a handle portion 14 having a handle axis 15. The handle portion has a force face 16, a front face 18, an aft face 20, and a stop face 22. A hole 24 is provided so the device 10 can be hung on a hook such as a nail for purposes of storage. A lanyard (not shown) may pass through the hole 24. The cam portion has a front 26, a back 28, and between them is an arcuate contact surface 30. The arcuate contact surface has a first end 32 and a second end 34. The first end of the arcuate contact surface adjoins the stop face 22. The second end adjoins a prong 36 that is adjacent to the force face 16. The prong 36 is made of a sturdy material such as metal and has a prong axis 37. The prong has a shaft 38 and an end 40. In this embodiment, the prong is straight, however, in other embodiments it may be curved or hook-like. This arrangement of the prong 36 and the handle portion 14 puts the axis 37 of the prong 36 approximately parallel to the axis 15 of the handle portion. An angle different from parallel, for instance up to 45 degrees, is contemplated by the invention. Also contemplated are prongs 36 of various shapes and axes. However, for a straight prong, as shown, the greater the angle the less the range of motion, and the less tightening may be done with a single use of the saddlery device 10.

FIG. 2 illustrates the saddlery device 10 being used on a saddle 42 resting on a pad 43 and a horse 44 that are shown in phantom lines. The saddle has billet straps 46, sometimes also known as girth tabs, and girth straps 48 that pass underneath the belly 50 of the horse. In this illustration, the girth strap comprises two straps 48 passing through a girth pad 51, but in some saddles there may be only one, and in other saddles, there may be more than two. For each girth strap 48, there is a billet strap 46. On the end of the girth straps 48 are buckles 52 having buckle prongs 54. In this illustration, the billet straps 46 have been passed through the buckles 52 and the prong 36 placed in a convenient hole 56 on one of the billet straps 46. A user's first hand 58 is on the force face 16 of the saddlery device 10 and the user's second hand 60, shown in phantom, is holding up a flap 62 of the saddle. The arcuate contact surface 30 rests on a buckle guard 64 directly over the billet strap 46. In this first or starting position, the prong 36 is between the horse 44 and the handle portion 14.

As the user lifts up on the handle portion 14 in the direction of the arrow, the handle acts as a lever and the cam portion 12 acts as a fulcrum. The cam portion rolls along the buckle guard 64 and billet strap 46 while the billet strap wraps around the arcuate contact surface 30 as seen in FIG. 3. The arcuate contact surface 30 is long and wide to securely wrap the billet strap 46. In this second or tight position, shown in FIG. 3, the prong 36 is not between the horse 44 and the handle portion 14. The rolling of the cam portion 12 and wrapping of the billet strap 46 brought additional holes 66 through the buckle 52. Either of these additional holes 66 is available for insertion of the buckle prong 54. Use of either of these additional holes 66 makes the girth strap tighter than if the buckle prong 54 had been inserted in the convenient hole 56.

After the buckle prong 54 is inserted, the saddlery device 10 may be removed from the convenient hole 56 and used on the other girth strap 48 to tighten it in a similar manner. To fully tighten the saddle 42 around the horse, the saddlery device 10 is used while alternating between the first girth strap 48 and any other girth strap(s) 48. After saddling the horse is complete, the saddlery device 10 may be hung in the barn or conveniently carried on the horse by a lanyard placed through the hole 24. The saddlery device is a one-piece lightweight design with a prong 36 that is not long or sharp so it can be safely tied to the saddle 42 to be with the rider should he need to use it again during the ride, or when re-saddling at a different location. This one-piece solid design that does not hurt the horse or make unnecessary sounds is another advantage of this device when compared to the prior art.

Materials used for making the saddlery device 10 may be metal, wood, plastic, or a variety of other materials, including composite materials, of appropriate weight and strength. It is contemplated that if made of plastic, it may be an open-framework design rather than a solid design. An open-framework design would be more manufacturing friendly, using less material and allowing consistent cooling by having consistent wall thicknesses. This is well known in the art of plastics manufacturing, to avoid areas of shrink or other manufacturing problems.

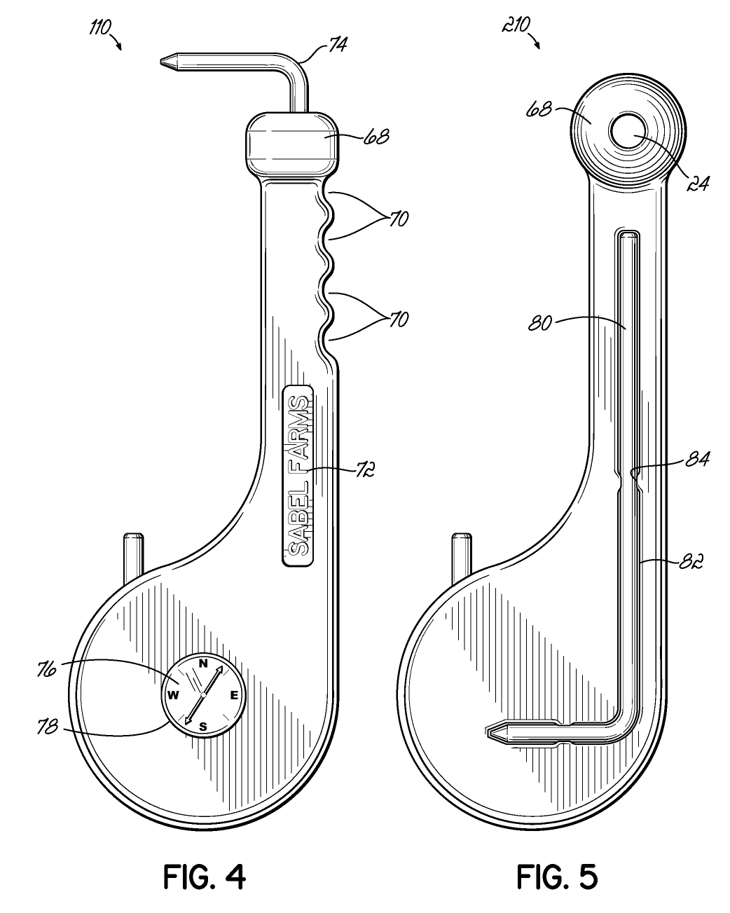

FIG. 4 illustrates a saddlery device 110 having additional features. The handle portion 14 has a bulbous end 68 and finger grips 70. One or both of item 68 and item 70 may be used. They need not be together as shown. An insignia 72 is placed on the handle portion 14 or at any desired location. A hoof pick 74 is molded or screwed into the device 10. This is used for cleaning the hooves of horses, and can be conveniently included my similar manufacturing methods used for the shaft 38. A compass 76 is positioned in a protective pocket 78 in the device 10. A compass is useful to a trail rider, and can be protected yet accessible if it is positioned in the device 10 that is brought along on the ride.

FIG. 5 illustrates a saddlery device 210 having additional features. The bulbous end 68 is round with a through hole 24 for a lanyard or for hanging. If the device 10 is of plastic, it would likely have multiple through holes 24 to avoid excessive wall thickness. A selectively removable hoof pick 80 is in a pocket 82 having retention tabs 84. It is contemplated that to remove this hoof pick 80, finger access will be provided in the form of open access from the reverse side (not shown) so that the hoof pick 80 can be pushed outwardly from its retention pocket 82. In the case of a plastic open-framework design, the finger access would be readily available.

While the foregoing description has set forth preferred embodiments of the present invention in particular detail, it must be understood that numerous modifications, substitutions and changes can be undertaken without departing from the true spirit and scope of the present invention as defined by the ensuing claims. The invention is therefore not limited to specific embodiments as described but is only limited as defined by the following claims.

What is claimed is:

1. A device for tightening a belt around an object comprising:
a cam with an arcuate surface that rotates over a holed-end of the belt;
a handle having a longitudinal axis that extends from a first end of the arcuate surface;
a prong sized to fit in a belt hole, having a longitudinal axis that extends from a second end of the arcuate surface and is approximately parallel to the longitudinal axis of the handle; and
wherein the device has a range of motion from a starting position whereat the prong lies between the handle and the object when the belt is loose, to an ending position whereat the handle lies between the prong and the object when the belt is tight.

2. The device of claim 1 wherein the cam, the handle, and the prong are fixedly attached to one another.

3. The device of claim 1 wherein the cam, the handle, and the prong are portions of the same integral piece.

4. The device of claim 1 wherein the cam and handle are made of wood and the prong is made of metal.

5. The device of claim 1 wherein the cam and handle are made of plastic and the prong is made of metal.

6. The device of claim 1 wherein the prong extends from the arcuate surface less than one inch.

7. A device for tightening a girth strap around a horse comprising:
a handle having a first longitudinal axis;
a prong having a second longitudinal axis that intersects the first axis;
a cam with an arcuate surface perpendicular to the plane containing the first longitudinal axis and the second longitudinal axis, wherein the arcuate surface has:
a first end proximate the handle,
a second end proximate the prong, and
an arc length of at least 270 degrees.

8. The device of claim 7 wherein the cam, the handle, and the prong are fixedly attached to one another.

9. The device of claim 7 wherein the cam, the handle, and the prong are portions of the same integral piece.

10. The device of claim 7 wherein the cam and handle are made of wood and the prong is made of metal.

11. The device of claim 7 wherein the cam and handle are made of plastic and the prong is made of metal.

12. The device of claim 7 wherein the prong extends from the arcuate surface less than one inch.

13. The device of claim 7 wherein the prong is threaded into the arcuate surface.
